(19) United States
(12) Patent Application Publication
(10) Pub. No.: US 2006/0168639 A1
(43) Pub. Date: Jul. 27, 2006

(54) Interactive television system with partial character set generator

(75) Inventors: Liang Gan, Shanghai (CN); Jingwei Tan, Shanghai (CN); Declan Patrick Kelly, Eindhoven (NL); Philip S. Newton, Eindhoven (NL); Jun Shi, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/537,593

(22) PCT Filed: Nov. 10, 2003
(86) PCT No.: PCT/IB03/05048

§ 371 Date: Jun. 6, 2005

Related U.S. Application Data
(60) Provisional application No. 60/432,067, filed on Dec. 9, 2002.

(51) Int. Cl. H04N 7/16; H04N 7/025; G06F 17/21; G06F 17/24; H04N 7/10; G06F 17/00

(52) U.S. Cl. 725/135; 725/32; 715/522

(57) ABSTRACT

An interactive television system includes a partial font generator (38) which generates a character font file of only those fonts used by a given application program for text display. The partial font file contains the language character fonts utilized by the application program, but less than the complete character set of the language. The partial font file thus requires less time or bandwidth to transmit in the allotted transmit intervals. The partial font file may be generated by a manual process, or by an automated analysis of the fonts used by application program.

This invention relates to interactive television systems and, more particularly, to interactive television system which generate and utilize partial character sets for language display.

In interactive television, video and audio streams and applications are multiplexed together to form one stream which is called the transportstream. The transportstream is transmitted to a viewer by the broadcaster and received by the viewer's television receiver. The transportstream is generally processed by a set-top box which is specially designed to process and execute the applications interleaved with the video and audio data in the transportstream. The applications can provide the viewer with unique or auxiliary information about a broadcast such as program listings and real time textual commentary, or interactive applications such as the ability to shop for goods and services by means of the television set.

Digital television set-top boxes have been based on many different hardware platforms and equipped with different types of real-time operating systems. This has resulted in set-top boxes and applications from different content providers and using different middleware application programming interfaces (APIs) being incompatible with each other. A viewer desiring access to a variety of interactive TV services is faced with the prospect of purchasing several set-top boxes with different encryption systems and hardware/software platforms, even when the boxes operate in accordance with the same broadcasting standards.

To address this situation of incompatibility and confusion, a European project called UNITEL by representatives of the European Broadcasting Union has developed an open middleware standard called the Multimedia Home Platform (MHP). MHP employs an open architecture which enables set-top box developers to develop applications for all MHP-compatible set-top boxes with no porting effort. MHP set-top boxes enable the reception and presentation of interactive applications in a vendor, author, and broadcaster neutral framework. At the core of the MHP specification is a Java virtual machine (DVB-J; Sun Microsystems) that can produce interactive applications with interoperability across broadcast networks. MHP also provides a platform for developing applications that can run on multiple cable, satellite, and terrestrial networks.

The interactive applications of MHP and the proprietary formats provide text, graphics, or pictures which must be multiplexed together with audio and video data streams to form the transportstream. The element streams can be multiplexed by an object or data carousel as specified in ISO13818-6, which operates to repeat each application or data element frequently so that a receiver can access the transportstream randomly and quickly acquire the application and its associated resource (image, graphic, font, etc.) The broadcast channel for the transportstream has a given bitrate for transmission, which must be used for both the application element streams and the audio/video element streams being transmitted over the channel. The need to repeatedly broadcast large application and resource files will diminish the channel bandwidth available for the video/audio streams and hence diminish the quality of the audio or video broadcast. When the application data is in the form of text, the broadcaster needs to provide at least one character file containing at least one character display font, either as a part of or annexed to the application. For applications in European languages, a file of less than two hundred characters will generally suffice for the desired character display, and can be transmitted in a file size of about 9 Kbytes. But for many languages such as those of East Asia, a full character set can be in excess of 20,000 characters, and can require many Mbytes to transmit. Since the character set must be transmitted at regularly recurring intervals so as to be virtually immediately available to new viewers, the interactive system can become unacceptably slow due to the transmission of these large language files. Accordingly it is desirable to be able to transmit necessary language character files, but without a detrimental effect on interactive system performance.

In accordance with the principles of the present invention, a partial font generator is provided for interactive television applications. The partial font generator analyzes the text required for an application and produces a partial font file containing those characters needed by the application. With this generator the service provider or application programmer can select the character set needed by a particular application, resulting in a relatively small character font file which can be quickly transmitted with reduced transmission time or bandwidth requirements. Repetitive transmission of small, custom-designed character font files reduce the overhead allocation of bandwidth and resultant slowdown of the interactive television broadcast.

In the drawings:

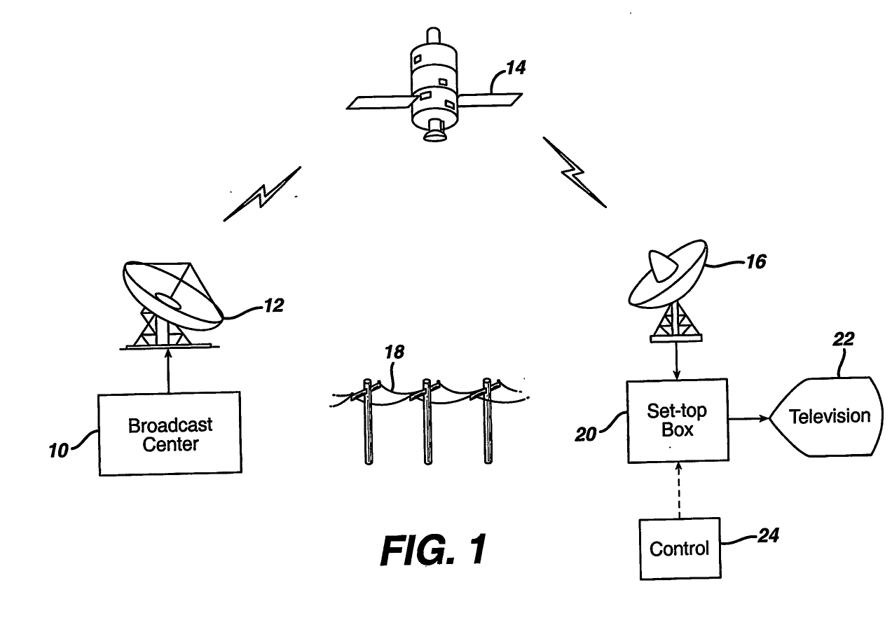

FIG. 1 illustrates the broadcasting and reception of digital interactive television;

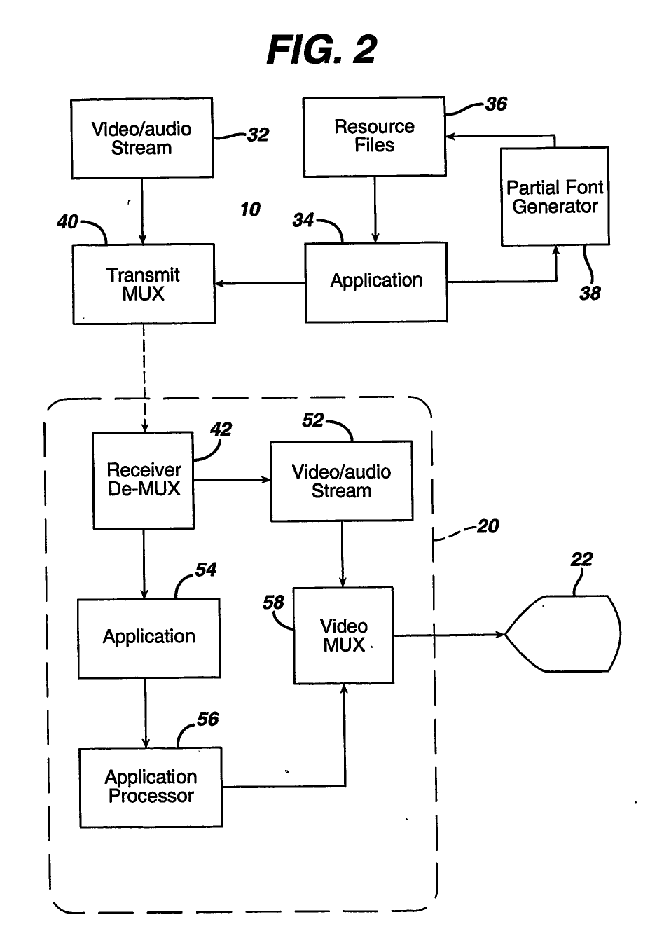

FIG. 2 illustrates the production, broadcast, and decoding of an interactive television broadcast by the broadcaster and a set-top box in accordance with the principles of the present invention;

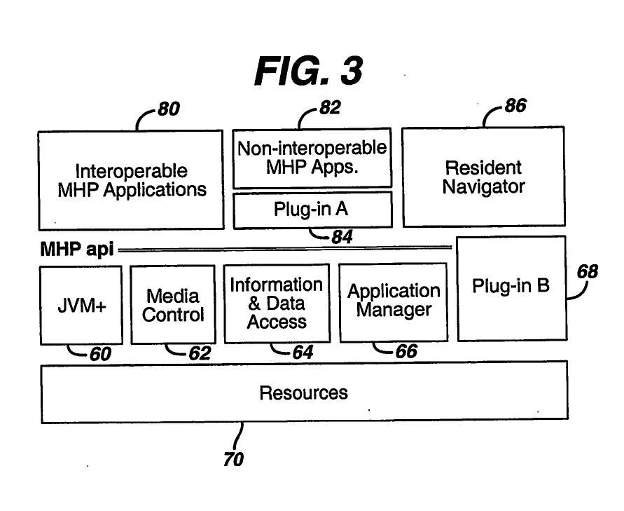

FIG. 3 illustrates the software components of an MHP stack;

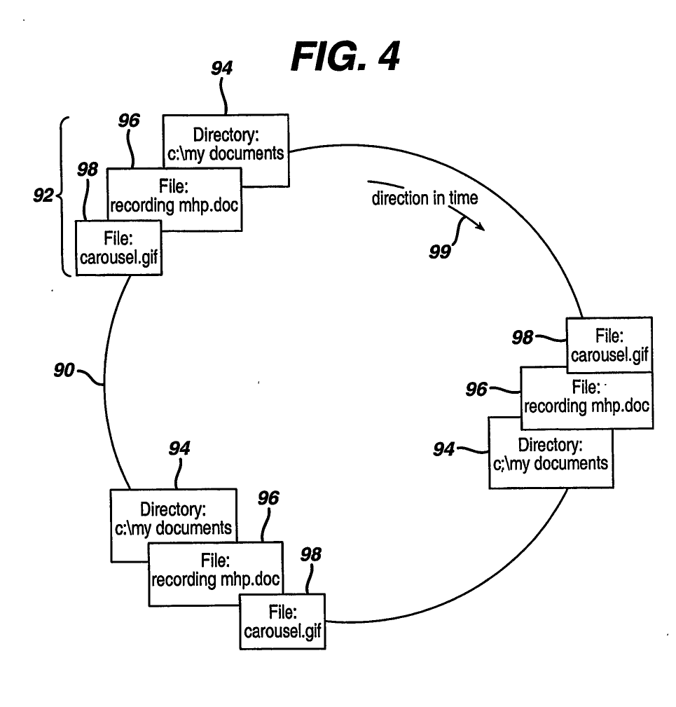

FIG. 4 illustrates an object carousel for an interactive television broadcast;

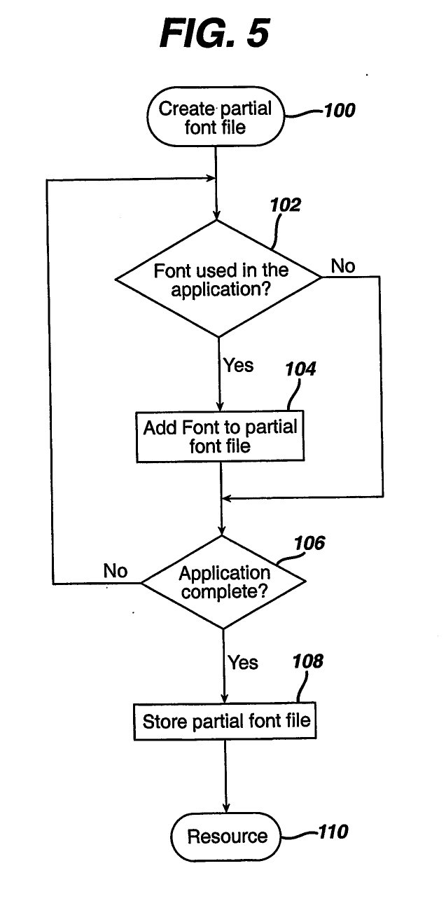

FIG. 5 is a flowchart illustrating the creation of a partial font file; and

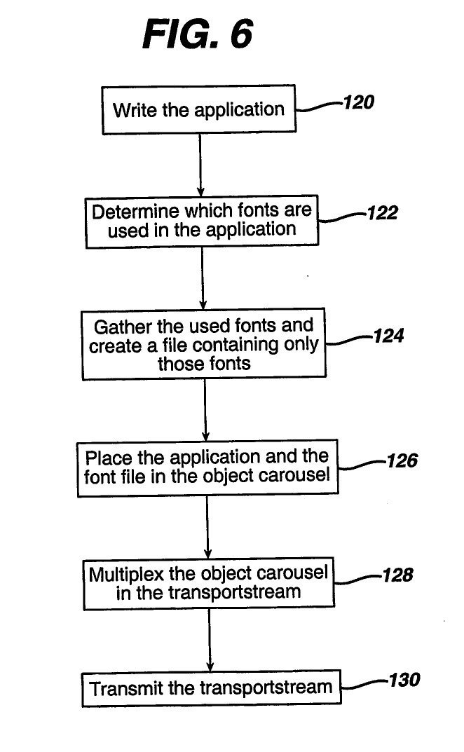

FIG. 6 is a flowchart illustrating the use of an application in conjunction with a partial font file.

Referring first to FIG. 1, an interactive television system is shown. The broadcast signal is sent by a broadcaster from a broadcast center 10. The broadcast signal is sent by a satellite transmitter 12 or a ground link 18, such as a coaxial or fiber optic cable, to viewers. In the case of the satellite link, the signals transmitted by the transmitter 12 are received by a satellite 14 and relayed to the antenna 16 of a viewer. The received signals are decoded and detected by a set-top box 20 and displayed on the television set 22. The set-top box is controlled by a user control 24 which may be a wired control or a remote control. The viewer uses the control to select desired programming or to interact with the broadcast content such as by selecting products or services for purchase by the viewer.

FIG. 2 illustrates the operation of the broadcast center 10 and the set-top box 20 in greater detail. A video/audio stream 32 which may comprise conventional television programming is coupled to a transmit multiplexer 40. An application processor 34 provides interactive applications to the multiplexer 40. The applications in a preferred embodiment are programmed in accordance with the MHP format. The applications may have associated with them or embedded in them data from resource files 36. In accordance with the principles of the present invention the applications are also applied to a partial font generator 38, which produces output character font files coupled to the resource file source 36. The audio/video data stream portion and the application program portion are mixed together by the transmit multiplexer 40 to produce a digital data stream transmitted to the set-top box 20.

The transmitted video/audio stream and application programs are received and separated in the set-top box 20 by a receiver de-multiplexer 42. The separated video/audio stream 52 is demodulated and processed for display by the television set 22. The video signals are coupled to a video multiplexer 58. The application programs separated at 54 by the de-multiplexer 42 comprise instructions and data to be executed by the set-top box and are processed by an application processor 56 for display on the television set, either in concert with the broadcast video from the stream 52 or as its own content source. In an application of the present invention the application program includes textual information such as a menu, programming information, or text relating to a broadcast TV program, including strings of characters in one or more languages. The application processor 56 is configured to receiver the application program and process the strings of characters of the application program and render the characters for display on the television set 22. The application programming is applied to the video multiplexer 58 from which it is applied to the television set as selected by the viewer control 24.

FIG. 3 illustrates the MHP application programming interface (API) which is preferred for a European implementation of the present invention. The MHP standard describes the functions and procedures that an application developer can use when writing an application that will execute in set-top boxes (digital TV receivers) that support the MHP platform. The standard also puts constrains on what the application developer can do so that the application will operate correctly on all set-top boxes supporting the MHP platform. The programmer performs a desired operation by calling functions in the application. The MHP API of FIG. 3 allows an application to perform operations (or have them performed) by calling function of a software library listed in the MHP stack. The API is based upon the Java platform, indicated by the Java virtual machine 60 at JVM+, which includes functionality by which an application can get and use a particular data set such as a character font. The objects or files transmitted to a viewer are images and Java files which constitute the interoperable MHP applications 80. The interactive programming may also contain non-interoperable MHP applications 82 and standard MHP functionality indicated by the plug-in A block 84. The media control block 62 in the MHP stack provides the functionality for the application to control the playback of video, for example, to call “fast forward” or “stop.” The information and data access block 64 allows an application to get information on system parameters as well as information about content, for example EPG information. This information can be carried in data tables transmitted in the stream, and can also be obtained through an Internet connection. The application manager 66 controls the lifecycle of applications. The application manager makes sure that an application operates correctly and can end an application that has stalled. The application manager 66 can claim resources from one application if another application has a need for more resources of the system. The plug-in B block 68 represents additional proprietary functionality which can be added by a manufacturer to its particular set-top box. Interoperable applications cannot use this functionality, as it is specific to a particular manufacturer. The resident navigator 86 is an application which is embedded in the set-top box. This is an application that allows the user to control basic functions when no other applications are present. The resident navigator controls what the viewer sees when the interactive system is initialized, for example. The resident navigator has special rights and can make use of proprietary functions not available to other applications, such as those of plug-in B. The resources 70 are the data handling functionality such as the underlying hardware and drivers available to the MHP application programmer.

Unlike the audio and video streams of a television broadcast, the application files are data files which are independent of time. The application files cannot be simple transmitted once during a broadcast, however. This is because a viewer turning on the television set or tuning to a new program in the middle of the broadcast must have access to the application at the time the viewer begins using or viewing the programming. For this reason the interactive television content is transmitted repetitively from an object carousel 90 such as that shown in FIG. 4. Every transmission from the carousel constitutes an entire file directory structure 92, including all of the data necessary to start using the content at a particular point in the broadcast. In the example of FIG. 4, each transmission includes three objects: a directory 94 and two files 96 and 98. As indicated by the circular arrow 99, the carousel of file structures 92 is repeated every time interval that the application is to be transmitted. A directory structure may be updated as needed or in concert with changes in the video programming, and an updated structure of object inserted in the carousel in place of outdated structures.

In accordance with the principles of the present invention, the transportstream includes a partial font file produced by a partial font generator 38. The partial font file consists of those characters necessary to support the instant application in one or more languages, and is less than the full set of characters for a given language. The partial font file can be generated in two ways. In one embodiment, the application developer manually creates the partial font file by selecting the fonts used in the application and placing them in a single file or package. In another embodiment a change is made in the Java software stack so that every time a new font is requested by an application it is added to the partial font file. As mentioned above, the MHP software stack shown in FIG. 3 is based for the most part on the Java platform. The Java platform includes functionality by which an application can get and use a particular character font. This function is called “Font.getFont (String name)” and is located in the java.awt package. By changing the implementation of this function such that when it gets called, the requested font is added to a subset of fonts (a partial font file), the generation of the partial font file can be performed automatically. All the broadcaster and/or the application developer would have to do is run the application through this modified Java/MHP platform and the subset of fonts would automatically be generated. In essence, the system of FIG. 2 analyzes which characters are used by an application and adds these to a library of fonts which is stored as a resource file. This library of fonts is inserted as a character font object file in the carousel, then transmitted together with the application in the transportstream. Alternatively the library of fonts is embedded in the application for insertion into the carousel and subsequent transmission. Since not all set-top boxes may have storage capability for character font files, the entire partial font file is transmitted during each transmit interval. The time to transmit a font file can thus be reduced significantly each transmit interval by the use of partial font files.

A process for generating a partial font file by means of a partial font generator is illustrated in the flowchart of FIG. 5. In block 100 the partial font file generator begins to analyze the fonts of an application. In block 102 the generator asks whether a particular font is used in the application. If the answer is “Yes,” the font is added to the partial font file in block 104 and the process continues with block 106. If the answer is “No,” the process drops immediately to block 106. In block 106 the generator asks whether the analysis of the application is complete. If the answer is “No,” the process goes back to block 102. If the answer is “Yes,” the partial font file is stored (block 108). The partial font file may be stored as a resource file (block 110) as shown in FIG. 2. The partial font file is subsequently embedded in the application or placed as a separate object in the object carousel, then transmitted in the transportstream.

FIG. 6 is a flowchart illustrating both the creation and transmission of an application and an associated partial font file. In block 120 the application programmer writes an application. In block 122 a manual process or an automated partial font generator determines which fonts are used in the application. In block 124 the fonts used in the application are gathered to create a partial font file containing those fonts used in the application. In block 126 the application and the partial font file are placed in the object carousel. In block 128 the object carousel is multiplexed in the transportstream, and in block 130 the transportstream is transmitted to a viewer's set-top box.

What is claimed is:

1. An interactive television system comprising:
a broadcast center (10) including a source of video signals, a source of application programs, and a source of font files comprising a partial font file containing the fonts applicable to a given application which is less than the full font file of a given language, and a transmitter (12) which acts to transmit the video signals, application programs and partial font files; and
an interactive television receiver responsive to the transmitted video signals application programs, and partial font files which displays text produced in response to the partial font files.

2. The interactive television system of claim 1, wherein the source of font files comprises a partial font generator (38).

3. The interactive television system of claim 1, wherein the video signals, application programs and partial font files are multiplexed in a transportstream; and
wherein the application programs are objects in an object carousel (90) multiplexed in the transportstream.

4. The interactive television system of claim 3, wherein the application programs and partial font files are separate objects of the object carousel (90).

5. The interactive television system of claim 3, wherein the partial font files are embedded in the application programs.

6. A method for generating a character font file for an application of an interactive television system comprising:
analyzing an interactive television application to determine if a particular font is used in the application;
if the particular font is used in the application, adding the font to a partial font file;
if the particular font is not used in the application, not adding the font to a partial font file; and
repeating the previous steps until the text of the application has been fully analyzed.

7. The method of claim 6, further comprising storing the partial font file after the application has been completely analyzed.

8. The method of claim 7, wherein storing comprises storing the partial font file as a resource file for the application.

9. The method of claim 7, further comprising placing the application and the partial font file in an object carousel (90).

10. The method of claim 9, further comprising transmitting the application and the partial font file to an interactive television receiver.

11. An interactive television system having a broadcast center comprising:
a source of video/audio streams;
a source of applications;
a partial font generator (38) responsive to the textual content of an application which produces a partial font file; and
a transmitter (12) responsive to a video/audio stream, an application, and a partial font file for the transmission of a transportstream.

12. The interactive television system of claim 11, wherein the partial font generator comprises the manual selection of fonts used in an application.

13. The interactive television system of claim 11, wherein the partial font generator (38) comprises an automated addition of a font newly requested by an application to a partial font file.

14. The interactive television system of claim 11, further comprising an interactive video receiver responsive to a received transport stream including:
a receiver which separates an application from a video/audio stream;
an application processor;
a video signal processor; and
a television display (22) coupled to the application processor and the video signal processor for the display of video and application content.

15. The interactive television system of claim 14, wherein the application processor is responsive to a partial font file for the display of textual information of an application on the television display (22).

16. The interactive television system of claim 11, wherein the source of applications comprises a source of applications compatible with the MHP standard.
